(19) United States
(12) Patent Application Publication
(10) Pub. No.: US 2017/0236400 A1
(43) Pub. Date: Aug. 17, 2017

(54) ALERT METHOD AND APPARATUS

(71) Applicant: Beijing Zhigu Rui Tuo Tech Co., Ltd, Beijing (CN)

(72) Inventor: Jia LIU, Beijing (CN)

(21) Appl. No.: 15/519,158

(22) PCT Filed: Jul. 24, 2015
(86) PCT No.: PCT/CN2015/085041

§ 371 Date: Apr. 14, 2017

(30) Foreign Application Priority Data
Oct. 17, 2014 (CN) 201410554367.8

(51) Int. Cl. G08B 21/24; H04W 8/24; H04W 4/02; H04B 17/318; H04L 12/26

(52) U.S. Cl. CPC G08B 21/24; H04B 17/318; H04L 43/16; H04W 4/021; H04W 4/023; H04W 8/24

(57) ABSTRACT

An alert method and apparatus are provided. A method comprises: in response to determining that at least one object is newly placed on an article holding apparatus associated with an alert apparatus and a wireless signal whose signal strength exceeds a first value is received, establishing, by the alert apparatus, at least one association relationship respectively between the at least one object and a user equipment (UE) sending the wireless signal, and alerting the UE that the at least one object is placed on the article holding apparatus based on the at least one association relationship. An alert solution is provided, which is applicable regardless of whether the object has a wireless communication capability.

### RELATED APPLICATION

The present international patent cooperative treaty (PCT) application claims the benefit of priority to Chinese Patent Application No. 201410554367.8, filed on Oct. 17, 2014, and entitled “Alert Method and Apparatus”, which is hereby incorporated into the present international PCT application by reference herein in its entirety.

### TECHNICAL FIELD

Embodiments of the present application relate to the field of communication technologies, and in particular, to an alert method and apparatus.

### BACKGROUND

When users go out from home, they sometimes forget articles such as mobile phones and keys. The existing BlueTooth (BT) 4.0 wireless communication technology supports a Proximity Profile, which can notify users when devices are away from each other to a certain extent by monitoring a change in signal strength between the devices, but the solution is not applicable to the articles, which have no wireless communication function.

### SUMMARY

In view of this, an example, non-limiting objective of embodiments of the present application is to provide an alert solution.

In one aspect, an example embodiment of the present application provides an alert method, comprising:
in response to determining that at least one object is newly placed on an article holding apparatus associated with an alert apparatus and a wireless signal whose signal strength exceeds a first value is received, establishing, by the alert apparatus, at least one association relationship respectively between the at least one object and a user equipment (UE) sending the wireless signal; and
alerting the UE that the at least one object is placed on the article holding apparatus based on the at least one association relationship.

In another aspect, an example embodiment of the present application provides an alert apparatus, comprising:
an association establishment module, configured to, in response to determining that at least one object is newly placed on an article holding apparatus associated with the alert apparatus and a wireless signal whose signal strength exceeds a first value is received, establish at least one association relationship respectively between the at least one object and a UE sending the wireless signal; and
an alert module, configured to alert the UE that the at least one object is placed on the article holding apparatus based on the at least one association relationship.

In another aspect, an example embodiment of the present application provides an alert apparatus, comprising:
a detection module, configured to detect whether at least one object is newly placed on an article holding apparatus associated with the alert apparatus;
a receiving module, configured to receive a wireless signal, and determine whether signal strength of the received wireless signal exceeds a first value;
an association module, configured to, in response to that the first detection module detects that at least one object is newly placed on the article holding apparatus and signal strength of the wireless signal received by the receiving module exceeds a first value, establish at least one association relationship respectively between the at least one object and a UE sending the wireless signal; and
a sending module, configured to send to the UE an alert indicating that the at least one object is placed on the article holding apparatus based on the at least one association relationship.

At least one technical solution has one or more of the following beneficial effects:
the embodiments of the present application, by, in response to determining that at least one object is newly placed on an article holding apparatus associated with an alert apparatus and a wireless signal whose signal strength exceeds a first value is received, establishing, by the alert apparatus, at least one association relationship respectively between the at least one object and a UE sending the wireless signal, and alerting the UE that the at least one object is placed on the article holding apparatus based on the at least one association relationship, provide an alert solution, which is applicable regardless of whether the object has a wireless communication capability.

### BRIEF DESCRIPTION OF THE DRAWINGS

FIG. 1 is a schematic flowchart of an example embodiment of an alert method according to the present application;

FIG. 2 is a schematic structural diagram of a first example embodiment of an alert apparatus according to the present application;

FIGS. 3-5 are respectively schematic structural diagrams of one optional implementation of the example embodiment shown in FIG. 2;

FIG. 6A is a schematic structural diagram of a second example embodiment of an alert apparatus according to the present application;

FIG. 6B and FIG. 6C are respectively schematic structural diagrams of one optional implementation of the example embodiment shown in FIG. 6A; and

FIG. 7 is a schematic structural diagram of a third example embodiment of an alert apparatus according to the present application.

### DETAILED DESCRIPTION

Example embodiments of the present application are further described in detail below with reference to the accompanying drawings and embodiments. The embodiments below are only used to describe the present application, but do not intend to limit the scope of the present application.

FIG. 1 is a schematic flowchart of an embodiment of an alert method according to the present application. As shown in FIG. 1, this embodiment comprises:
110. In response to determining that at least one object is newly placed on an article holding apparatus associated with an alert apparatus and a wireless signal whose signal strength exceeds a first value is received, the alert apparatus establishes at least one association relationship respectively between the at least one object and a UE sending the wireless signal.

In this embodiment, the alert apparatus is optionally an alert apparatus in the first or second or third embodiment of the alert apparatus according to the present application.

In this embodiment, the article holding apparatus is an apparatus configured to place articles, such as a table, a table mat, a shelf, a drawer or a chest.

In this embodiment, the alert apparatus and the article holding apparatus associated with the alert apparatus are usually set together. For example, the article holding apparatus is a table, and the alert apparatus is attached to or embedded into the table top of the table, and optionally, the alert apparatus is attached to an upper side or a lower side of the table top.

In this embodiment, the “newly placed” refers to “additionally placed”. For example, if no articles are originally placed on the article holding apparatus, when a user places an article A on the article holding apparatus, it is equivalent to that the article A is newly placed on the article holding apparatus; if the article A is originally placed on the article holding apparatus, when the user places an article B on the article holding apparatus, it is equivalent to that the article B is newly placed on the article holding apparatus.

In this embodiment, that the signal strength of the wireless signal sent by the UE received by the alert apparatus exceeds the first value means that the distance between the alert apparatus and the UE is close enough, and as the alert apparatus and the article holding apparatus associated with the alert apparatus are usually set together, it is equivalent to that the distance between the article holding apparatus and the UE is also close enough. The first value is optionally a preset value. Optionally, the wireless signal is sent by the UE periodically, and further optionally, the wireless signal is a broadcast signal sent by the UE periodically.

In this embodiment, the UE is generally a device easy to prompt users. Optionally, the UE is a portable device, such as a mobile phone, a smartband, or a smart necklace. For example, a user uses the left hand wearing a smartband to place a key on a table, at this time, the alert apparatus associated with the table determines that an article is newly placed on the table, that is, the key, and a wireless signal whose signal strength exceeds the first value sent by the smartband is received, and correspondingly, the alert apparatus establishes an association relationship between the key and the smartband.
120. Alert the UE that the at least one object is placed on the article holding apparatus based on the at least one association relationship.

For example, if a first UE is respectively associated with an article A and an article B in the at least one association relationship, the alert apparatus alerts the first UE that the article A and the article B are placed on the article holding apparatus; if a second UE is associated with an article C in the at least one association relationship, the alert apparatus alerts the second UE that the article C is placed on the article holding apparatus.

In this embodiment, after 120, the UE may alert the user according to an alert of the alert apparatus.

This embodiment, by, in response to determining that at least one object is newly placed on an article holding apparatus associated with an alert apparatus and a wireless signal whose signal strength exceeds a first value is received, establishing, by the alert apparatus, at least one association relationship respectively between the at least one object and a UE sending the wireless signal, and alerting the UE that the at least one object is placed on the article holding apparatus based on the at least one association relationship, provides an alert solution, which is applicable no matter whether the object has wireless communication capability.

The method of this embodiment is further described below through some example embodiments.

In this embodiment, before 110, the alert apparatus further determines whether at least one object is newly placed on the article holding apparatus, and determines whether a wireless signal whose signal strength exceeds a first value is received.

In one example embodiment, before the in response to determining that at least one object is newly placed on an article holding apparatus associated with an alert apparatus and a wireless signal whose signal strength exceeds a first value is received, establishing, by the alert apparatus, at least one association relationship respectively between the at least one object and a UE sending the wireless signal, the method further comprises:
determining, by the alert apparatus, whether at least one object is newly placed on the article holding apparatus; and in response to determining that the at least one object is newly placed on the article holding apparatus, determining whether a wireless signal whose signal strength exceeds a first value is received within a first period of time.

The first period of time is relevant to the time when at least one object is newly placed on the article holding apparatus. Optionally, the first period of time is a period of time that takes the time when at least one object is newly placed on the article holding apparatus as an intermediate point. Specifically, duration of the first period of time may be preset.

For example, the alert apparatus determines that at least one object is newly placed on the article holding apparatus at time t1, and then determines whether a wireless signal whose signal strength exceeds a first value is received within a first period of time near the time t1.

In another example embodiment, before the in response to determining that at least one object is newly placed on an article holding apparatus associated with an alert apparatus and a wireless signal whose signal strength exceeds a first value is received, establishing, by the alert apparatus, at least one association relationship respectively between the at least one object and a UE sending the wireless signal, the method further comprises:
determining, by the alert apparatus, whether a wireless signal whose signal strength exceeds a first value is received; and in response to that the wireless signal whose signal strength exceeds a first value is received, determining, by the alert apparatus, whether at least one object is newly placed on the article holding apparatus within a second period of time.

The second period of time is relevant to the time when the alert apparatus receives a wireless signal whose signal strength exceeds a first value. Optionally, the second period of time is a period of time that takes the time when the alert apparatus receives a wireless signal whose signal strength exceeds a first value as an intermediate point. Specifically, duration of the second period of time may be preset.

For example, the alert apparatus receives a wireless signal at time t2, wherein signal strength of the wireless signal exceeds the first value, and then determines whether at least one object is newly placed on the article holding apparatus within a second period of time near the time t2.

In this embodiment, the alert apparatus may immediately perform 120 after 110, or may perform 120 only if a certain condition is met after 110.

In one example embodiment, the alerting the UE that the at least one object is placed on the article holding apparatus based on the at least one association relationship comprises:
alerting the UE that the at least one object is placed on the article holding apparatus based on the at least one association relationship in response to that a query request from the UE is received.

In another example embodiment, the alerting the UE that the at least one object is placed on the article holding apparatus based on the at least one association relationship comprises:
alerting the UE that the at least one object is placed on the article holding apparatus based on the at least one association relationship in response to that the UE is located in a preset region.

The preset region may be a region set previously, such as a doorway.

Whether the UE is located in a preset region may be determined in many manners, which comprise, but are not limited to: the alert apparatus detects the position of the UE and judges whether the UE is located in a preset region, or the UE detects its own position, judges whether the UE is located in a preset region and notifies the alert apparatus of the result, or the UE detects its own position and notifies the alert apparatus of the position, and the alert apparatus determines whether the UE is located in a preset region, or a third-party device other than the alert apparatus and the UE detects the position of the UE, judges whether the UE is located in a preset region and notifies the alert apparatus of the result, or the like.

In another example embodiment, the alerting the UE that the at least one object is placed on the article holding apparatus based on the at least one association relationship comprises:
alerting the UE that the at least one object is placed on the article holding apparatus based on the at least one association relationship in response to that a distance between the UE and the article holding apparatus exceeds a second value.

The second value may be a value set previously, such as 10 m.

Whether a distance between the UE and the article holding apparatus exceeds a second value may be determined in many manners, which comprise, but are not limited to: the alert apparatus detects positions of the article holding apparatus and the UE and judges whether a distance therebetween exceeds a second value, or the UE detects its own position and the position of the article holding apparatus, judges whether a distance therebetween exceeds a second value and notifies the alert apparatus of the result, or the UE detects its own position and notifies the alert apparatus of the position, and the alert apparatus detects the position of the article holding apparatus and judges whether a distance between the UE and the article holding apparatus exceeds a second value, or a third-party device other than the alert apparatus and the UE detects the position of the article holding apparatus and the position of the UE, judges whether a distance therebetween exceeds a second value and notifies the alert apparatus of the result, or the like.

As the alert apparatus and the article holding apparatus are usually set together, the distance between the UE and the alert apparatus is equivalent to the distance between the UE and the article holding apparatus.

It is noted that, in the example embodiment that the alert apparatus immediately performs 120 after 110, the UE may also alert the user according to the alert of the alert apparatus when any of the above conditions is met, for example, the UE alerts the user that the at least one object is placed on the article holding apparatus in response to determining that the UE is located in a preset region.

In this embodiment, in order to identify the at least one object newly placed on the article holding apparatus, optionally, the in response to determining that at least one object is newly placed on an article holding apparatus associated with an alert apparatus and a wireless signal whose signal strength exceeds a first value is received, establishing, by the alert apparatus, at least one association relationship respectively between the at least one object and a UE sending the wireless signal comprises:
in response to determining that at least one object is newly placed on the article holding apparatus and a wireless signal whose signal strength exceeds a first value is received, acquiring, by the alert apparatus, placement information of the at least one object, and establishing at least one association relationship respectively between the placement information of the at least one object and a UE sending the wireless signal.

The placement information optionally comprises at least one of the following: an image, a shape, weight, a material and a placement region. Specifically, various kinds of placement information may be detected through corresponding sensors. For example, the image of each object may be detected through a visual sensor; the shape of each object may be detected through an ultrasonic distance sensor, an infrared sensor or the like; the weight of each object may be detected through various weighing sensors, for example, a resistance strain weighing sensor, an electromagnetic weighing sensor, a capacitance weighing sensor and the like; the material of each object may be detected through an inductive proximity sensor, a capacitive proximity sensor, a Hall proximity sensor, a photoelectric sensor or the like; the placement region of each object may be detected through various position sensors, such as an electromagnetic position sensor, a photoelectric position sensor, a differential transformer position sensor, an eddy-current position sensor, a capacitive position sensor, a reed switch position sensor, a Hall position sensor and the like.

In order to achieve a clearer alert, optionally, the alerting the UE that the at least one object is placed on the article holding apparatus based on the at least one association relationship comprises: sending the placement information of the at least one object to the UE based on the at least one association relationship.

That is to say, the placement information of the at least one object is taken as the alert.

For example, after receiving a query request from the UE, the alert apparatus sends the placement information of the at least one object to the UE based on the at least one association relationship.

In this embodiment, the object placed on the article holding apparatus may be removed, and further may be removed before 120.

In one example embodiment, the at least one object is a plurality of objects;
after the establishing at least one association relationship respectively between the at least one object and a UE sending the wireless signal, the method further comprises: in response to determining that at least one object in the plurality of objects is removed from the article holding apparatus, deleting at least one association relationship respectively between the removed at least one object and the UE; and
the alerting the UE that the at least one object is placed on the article holding apparatus based on the at least one association relationship comprises: in response to that there is still at least one object in the plurality of objects placed on the article holding apparatus after the at least one object in the plurality of objects is removed from the article holding apparatus, alerting the UE that at least one object in the plurality of objects except the removed at least one object is placed on the article holding apparatus based on at least one remaining association relationship.

For example, the user uses the left hand wearing a smartband to place two books (represented with a book A and a book B for ease of description) on a table, at this time, the alert apparatus associated with the table determines that two objects are newly placed on the table, that is, the book A and the book B, and a wireless signal whose signal strength exceeds the first value sent by the smartband is received, and correspondingly, the alert apparatus establishes two association relationship respectively between the book A and the book B and the smartband; afterwards, the alert apparatus determines that the book A is removed from the table and deletes the association relationship between the book A and the smartband, and correspondingly, the association relationship between the book B and the smartband remains; then, the alert apparatus receives a query request from the smartband, and alerts the smartband that the book B is placed on the table based on the remaining association relationship.

It is noted that, if, before 120, all the objects associated with the UE are removed from the article holding apparatus, it is unnecessary to perform 120.

In this embodiment, optionally, the wireless signal carries a device ID of the UE; and the establishing at least one association relationship respectively between the at least one object and a UE sending the wireless signal comprises: establishing at least one association relationship respectively between the at least one object and the device ID.

For example, in the implementation of acquiring the placement information, optionally, at least one association relationship respectively between the placement information of the at least one object and the device ID is established.

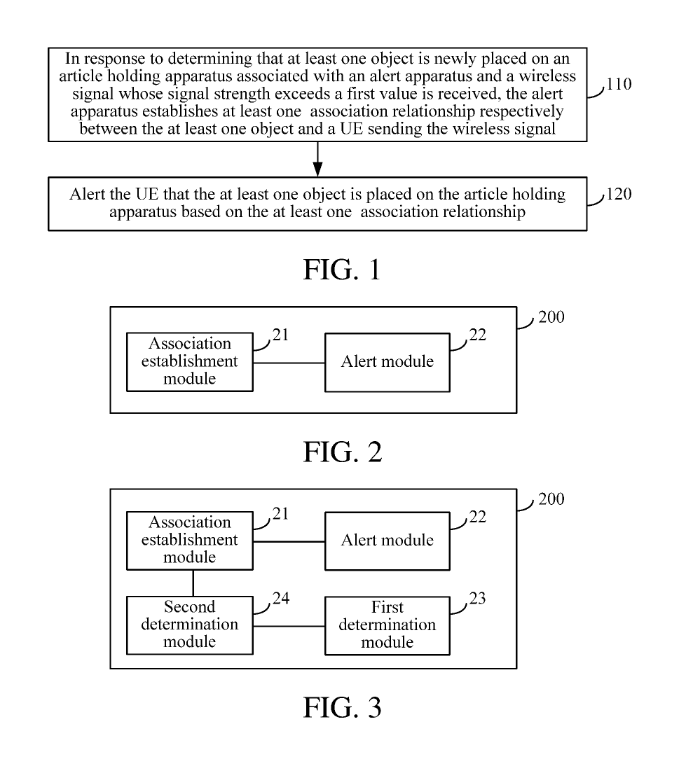

FIG. 2 is a schematic structural diagram of a first embodiment of an alert apparatus according to the present application. As shown in FIG. 2, the alert apparatus 200 comprises:
an association establishment module 21, configured to, in response to determining that at least one object is newly placed on an article holding apparatus associated with the alert apparatus 200 and a wireless signal whose signal strength exceeds a first value is received, establish at least one association relationship respectively between the at least one object and a UE sending the wireless signal; and
an alert module 22, configured to alert the UE that the at least one object is placed on the article holding apparatus based on the at least one association relationship.

In this embodiment, the article holding apparatus is an apparatus configured to place articles, such as a table, a table mat, a shelf, a drawer or a chest.

In this embodiment, the alert apparatus 200 and the article holding apparatus associated with the alert apparatus 200 are usually set together. For example, the article holding apparatus is a table, and the alert apparatus 200 is attached to or embedded into the table top of the table, and optionally, the alert apparatus 200 is attached to an upper side or a lower side of the table top.

In this embodiment, the “newly placed” refers to “additionally placed”. For example, if no articles are originally placed on the article holding apparatus, when a user places an article A on the article holding apparatus, it is equivalent to that the article A is newly placed on the article holding apparatus; if the article A is originally placed on the article holding apparatus, when the user places an article B on the article holding apparatus, it is equivalent to that the article B is newly placed on the article holding apparatus.

In this embodiment, that the signal strength of the wireless signal sent by the UE received by the alert apparatus 200 exceeds the first value means that the distance between the alert apparatus 200 and the UE is close enough, and as the alert apparatus 200 and the article holding apparatus associated with the alert apparatus 200 are usually set together, it is equivalent to that the distance between the article holding apparatus and the UE is also close enough. The first value is optionally a preset value. Optionally, the wireless signal is sent by the UE periodically, and further optionally, the wireless signal is a broadcast signal sent by the UE periodically.

In this embodiment, the UE is generally a device easy to prompt users. Optionally, the UE is a portable device, such as a mobile phone, a smartband, or a smart necklace. For example, a user uses the left hand wearing a smartband to place a key on a table, at this time, the alert apparatus 200 associated with the table determines that an article is newly placed on the table, that is, the key, and a wireless signal whose signal strength exceeds the first value sent by the smartband is received, and correspondingly, the association establishment module 21 in the alert apparatus 200 establishes an association relationship between the key and the smartband.

For example, if a first UE is respectively associated with an article A and an article B in the at least one association relationship established by the association establishment module 21, the alert module 22 alerts the first UE that the article A and the article B are placed on the article holding apparatus; if a second UE is associated with an article C in the at least one association relationship established by the association establishment module 21, the alert module 22 alerts the second UE that the article C is placed on the article holding apparatus.

In this embodiment, after receiving an alert of the alert module 22, the UE may alert the user.

The alert apparatus in this embodiment, by, in response to determining that at least one object is newly placed on an article holding apparatus associated with the alert apparatus and a wireless signal whose signal strength exceeds a first value is received, establishing, by an association establishment module, at least one association relationship respectively between the at least one object and a UE sending the wireless signal, and alerting, by an alert module, the UE that the at least one object is placed on the article holding apparatus based on the at least one association relationship, provides an alert solution, which is applicable no matter whether the object has wireless communication capability.

The alert apparatus 200 in this embodiment is further described below through some example embodiments.

In this embodiment, before 110, the alert apparatus 200 further determines whether at least one object is newly placed on the article holding apparatus, and determines whether a wireless signal whose signal strength exceeds a first value is received.

In one example embodiment, as shown in FIG. 3, the alert apparatus 200 further comprises:
a first determination module 23, configured to determine whether at least one object is newly placed on the article holding apparatus; and a second determination module 24, configured to, in response to that the first determination module 23 determines that the at least one object is newly placed on the article holding apparatus, determine whether a wireless signal whose signal strength exceeds a first value is received within a first period of time.

Correspondingly, the association establishment module 21 is configured to, in response to that the first determination module 23 determines that at least one object is newly placed on an article holding apparatus associated with the alert apparatus 200 and the second determination module 24 determines that a wireless signal whose signal strength exceeds a first value is received, establish an association relationship between the at least one object and a UE sending the wireless signal.

The first period of time is relevant to the time when at least one object is newly placed on the article holding apparatus. Optionally, the first period of time is a period of time that takes the time when at least one object is newly placed on the article holding apparatus as an intermediate point. Specifically, duration of the first period of time may be preset.

For example, the first determination module 23 determines that at least one object is newly placed on the article holding apparatus at time t1, and the second determination module 24 determines whether a wireless signal whose signal strength exceeds a first value is received within a first period of time near the time t1.

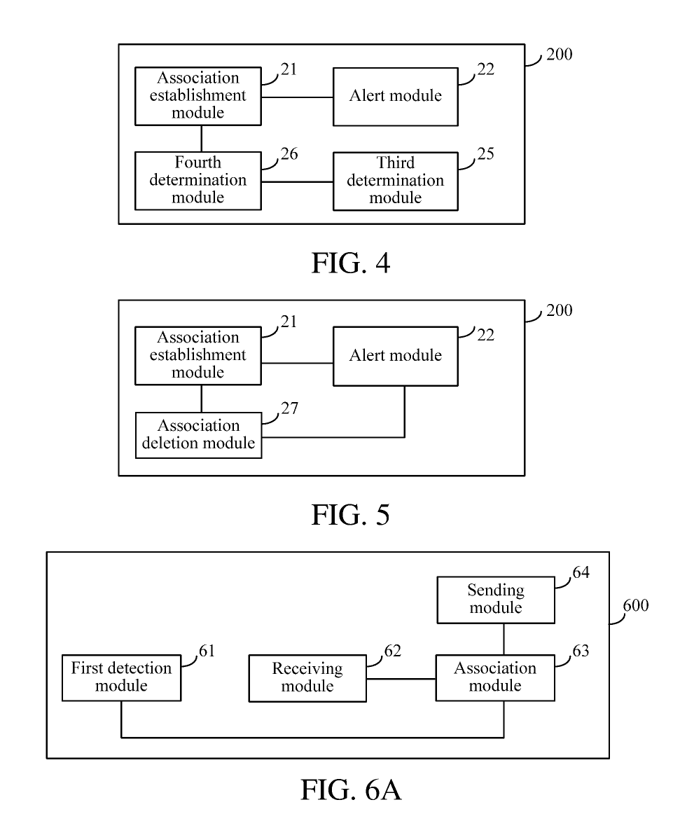

In another example embodiment, as shown in FIG. 4, the alert apparatus 200 further comprises:
a third determination module 25, configured to determine whether a wireless signal whose signal strength exceeds a first value is received; and a fourth determination module 26, configured to, in response to that the third determination module 25 determines that the wireless signal whose signal strength exceeds a first value is received, determine whether at least one object is newly placed on the article holding apparatus within a second period of time.

Correspondingly, the association establishment module 21 is configured to, in response to that the fourth determination module 26 determines that at least one object is newly placed on an article holding apparatus associated with the alert apparatus 200 and the third determination module 25 determines that a wireless signal whose signal strength exceeds a first value is received, establish an association relationship between the at least one object and a UE sending the wireless signal.

The second period of time is relevant to the time when the alert apparatus 200 receives a wireless signal whose signal strength exceeds a first value. Optionally, the second period of time is a period of time that takes the time when the alert apparatus 200 receives a wireless signal whose signal strength exceeds a first value as an intermediate point. Specifically, duration of the second period of time may be preset.

For example, the alert apparatus 200 receives a wireless signal at time t2, the third determination module 25 determines that signal strength of the wireless signal exceeds the first value, and the fourth determination module 26 determines whether at least one object is newly placed on the article holding apparatus within a second period of time near the time t2.

In this embodiment, the alert module 22 may immediately alert the UE after the association establishment module 21 establishes the at least one association relationship, or may alert the UE only if it is determined that a certain condition is met after the association establishment module 21 establishes the at least one association relationship

In one example embodiment, the alert module 22 is specifically configured to:
alert the UE that the at least one object is placed on the article holding apparatus based on the at least one association relationship in response to that a query request from the UE is received.

In another example embodiment, the alert module 22 is specifically configured to:
alert the UE that the at least one object is placed on the article holding apparatus based on the at least one association relationship in response to that the UE is located in a preset region.

The preset region may be a region set previously, such as a doorway.

Whether the UE is located in a preset region may be determined in many manners, which comprise, but are not limited to: the alert apparatus 200 detects the position of the UE and judges whether the UE is located in a preset region, or the UE detects its own position, judges whether the UE is located in a preset region and notifies the alert apparatus 200 of the result, or the UE detects its own position and notifies the alert apparatus 200 of the position, and the alert apparatus 200 determines whether the UE is located in a preset region, or a third-party device other than the alert apparatus 200 and the UE detects the position of the UE, judges whether the UE is located in a preset region and notifies the alert apparatus 200 of the result, or the like.

In another example embodiment, the alert module 22 is specifically configured to:
alert the UE that the at least one object is placed on the article holding apparatus based on the at least one association relationship in response to that a distance between the UE and the article holding apparatus exceeds a second value.

The second value may be a value set previously, such as 10 m.

Whether a distance between the UE and the article holding apparatus exceeds a second value may be determined in many manners, which comprise, but are not limited to: the alert apparatus 200 detects positions of the article holding apparatus and the UE and judges whether a distance therebetween exceeds a second value, or the UE detects its own position and the position of the article holding apparatus, judges whether a distance therebetween exceeds a second value and notifies the alert apparatus 200 of the result, or the UE detects its own position and notifies the alert apparatus 200 of the position, and the alert apparatus 200 detects the position of the article holding apparatus and judges whether a distance between the UE and the article holding apparatus exceeds a second value, or a third-party device other than the alert apparatus 200 and the UE detects the position of the article holding apparatus and the position of the UE, judges whether a distance therebetween exceeds a second value and notifies the alert apparatus 200 of the result, or the like.

As the alert apparatus 200 and the article holding apparatus associated with the alert apparatus 200 are usually set together, the distance between the UE and the alert apparatus 200 is equivalent to the distance between the UE and the article holding apparatus.

It is noted that, in the example embodiment that the alert apparatus 200 immediately alerts the UE after the association relationship module 21 establishes the at least one association relationship, the UE may also alert the user according to the alert of the alert module 22 when any of the above conditions is met, for example, the UE alerts the user that the at least one object is placed on the article holding apparatus in response to determining that the UE is located in a preset region.

In this embodiment, in order to identify the at least one object newly placed on the article holding apparatus, optionally, the association relationship module 21 is specifically configured to: in response to determining that at least one object is newly placed on the article holding apparatus and a wireless signal whose signal strength exceeds a first value is received, acquire placement information of the at least one object, and establish at least one association relationship respectively between the placement information of the at least one object and a UE sending the wireless signal.

The placement information optionally comprises at least one of the following: an image, a shape, weight, a material and a placement region. Specifically, various kinds of placement information may be detected through corresponding sensors. For example, the image of each object may be detected through a visual sensor; the shape of each object may be detected through an ultrasonic distance measurement sensor, an infrared sensor or the like; the weight of each object may be detected through various weighing sensors, for example, a resistance strain weighing sensor, an electromagnetic weighing sensor, a capacitance weighing sensor and the like; the material of each object may be detected through an inductive proximity sensor, a capacitive proximity sensor, a Hall proximity sensor, a photoelectric sensor or the like; the placement region of each object may be detected through various position sensors, such as an electromagnetic position sensor, a photoelectric position sensor, a differential transformer position sensor, an eddy-current type position sensor, a capacitive position sensor, a reed switch position sensor, a Hall position sensor and the like.

In order to achieve a clearer alert, optionally, the alert module 22 is specifically configured to:
send the placement information of the at least one object to the UE based on the at least one association relationship.

That is to say, the placement information of the at least one object is taken as the alert.

For example, after receiving a query request from the UE, the alert module 22 sends the placement information of the at least one object to the UE based on the at least one association relationship.

In this embodiment, the object placed on the article holding apparatus may be removed, and further may be removed before the alert module 22 alerts the UE.

In one example embodiment, the at least one object is a plurality of objects;
as shown in FIG. 5, the alert apparatus 200 further comprises: an association deletion module 27, configured to, in response to determining that at least one object in the plurality of objects is removed from the article holding apparatus, delete at least one association relationship respectively between the removed at least one object and the UE; and
the alert module 22 is specifically configured to: in response to that there is still at least one object in the plurality of objects placed on the article holding apparatus after the at least one object in the plurality of objects is removed from the article holding apparatus, alert the UE that at least one object in the plurality of objects except the removed at least one object is placed on the article holding apparatus based on at least one remaining association relationship.

For example, the user uses the left hand wearing a smartband to place two books (represented with a book A and a book B for ease of description) on a table, at this time, the first determination module 23 determines that two objects are newly placed on the table, that is, the book A and the book B, and the second determination module 24 determines that a wireless signal whose signal strength exceeds the first value sent by the smartband is received, and correspondingly, the association establishment module 21 establishes two association relationship respectively between the book A and the book B and the smartband; afterwards, the book A is removed from the table, the association deletion module 27 deletes the association relationship between the book A and the smartband, and correspondingly, the association relationship between the book B and the smartband remains; then, the alert module 22 receives a query request from the smartband, and alerts the smartband that the book B is placed on the table based on the remaining association relationship.

It is noted that, if, before the alert module 22 alerts the UE, all the objects associated with the UE are removed from the article holding apparatus, it is unnecessary to alert the UE.

In this embodiment, optionally, the wireless signal carries a device ID of the UE; and the association establishment module 21 is specifically configured to: in response to that it is determined that at least one object is newly placed on an article holding apparatus associated with the alert apparatus 200 and a wireless signal whose signal strength exceeds a first value is received, establish at least one association relationship respectively between the at least one object and the device ID.

For example, in the implementation of acquiring the placement information, optionally, the association establishment module 21 is specifically configured to: in response to that it is determined that at least one object is newly placed on an article holding apparatus associated with the alert apparatus 200 and a wireless signal whose signal strength exceeds a first value is received, acquire placement information of the at least one object, and establish at least one association relationship respectively between the placement information of the at least one object and the device ID.

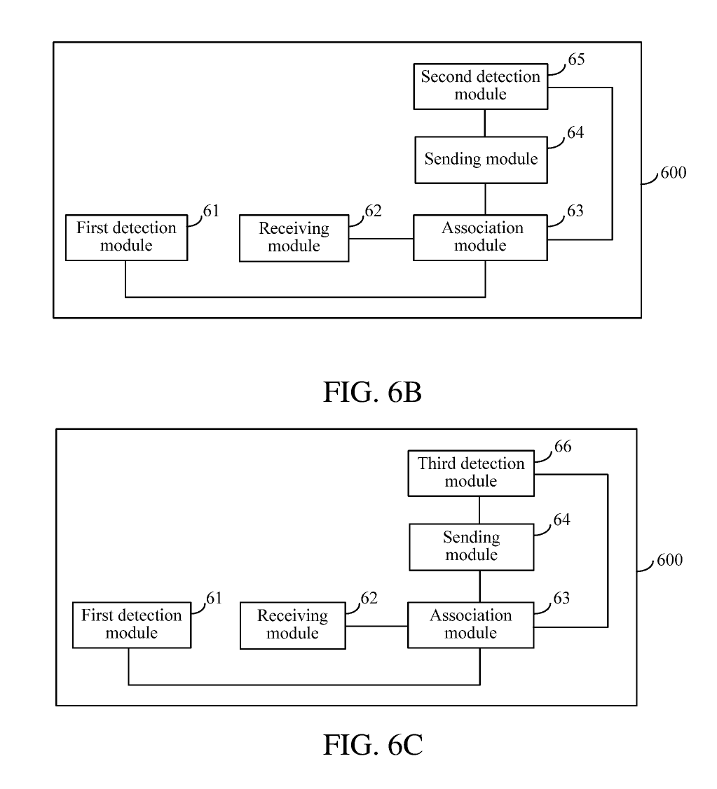

FIG. 6A is a schematic structural diagram of a second embodiment of an alert apparatus according to the present application. As shown in FIG. 6A, the alert apparatus 600 comprises:
a first detection module 61, configured to detect whether at least one object is newly placed on an article holding apparatus associated with the alert apparatus 600;
a receiving module 62, configured to receive a wireless signal, and determine whether signal strength of the received wireless signal exceeds a first value;
an association module 63, configured to, in response to that the first detection module 61 detects that at least one object is newly placed on the article holding apparatus and signal strength of the wireless signal received by the receiving module 62 exceeds a first value, establish at least one association relationship respectively between the at least one object and a UE sending the wireless signal; and
a sending module 64, configured to send to the UE an alert indicating that the at least one object is placed on the article holding apparatus based on the at least one association relationship.

In this embodiment, the article holding apparatus is an apparatus configured to place articles, such as a table, a table mat, a shelf, a drawer or a chest.

In this embodiment, the alert apparatus 600 and the article holding apparatus associated with the alert apparatus 600 are usually set together. For example, the article holding apparatus is a table, and the alert apparatus 600 is attached to or embedded into the table top of the table, and optionally, the alert apparatus 600 is attached to an upper side or a lower side of the table top.

In this embodiment, the “newly placed” refers to “additionally placed”. For example, if no articles are originally placed on the article holding apparatus, when a user places an article A on the article holding apparatus, the first detection module 61 detects that the article A is newly placed on the article holding apparatus; if the article A is originally placed on the article holding apparatus, when the user places an article B on the article holding apparatus, the first detection module 61 detects that the article B is newly placed on the article holding apparatus.

In this embodiment, that the signal strength of the wireless signal sent by the UE received by the receiving module 62 exceeds the first value means that the distance between the alert apparatus 600 and the UE is close enough, and as the alert apparatus 600 and the article holding apparatus associated with the alert apparatus 600 are usually set together, it is equivalent to that the distance between the article holding apparatus and the UE is also close enough. The first value is optionally a preset value. Optionally, the wireless signal is sent by the UE periodically, and further optionally, the wireless signal is a broadcast signal sent by the UE periodically.

In this embodiment, the UE and the receiving module 62 perform communication by using a wireless communication technology. The wireless communication technology comprises, but is not limited to, BT, WiFi, Zigbee, infrared and the like. Optionally, the UE and the receiving module 62 perform communication by using a BT wireless communication technology, and correspondingly, the receiving module 62 comprises a BT communication unit.

In this embodiment, the UE is generally a device easy to prompt users. Optionally, the UE is a portable device, such as a mobile phone, a smartband, or a smart necklace. For example, a user uses the left hand wearing a smartband to place a key on a table, at this time, the first detection module 61 in the alert apparatus 600 associated with the table detects that an article is newly placed on the table, that is, the key, and the receiving module 62 receives a wireless signal whose signal strength exceeds the first value sent by the smartband, and correspondingly, the association module 63 establishes an association relationship between the key and the smartband.

In this embodiment, the sending module 64 sends the alert to the UE by using a wireless communication technology. The wireless communication technology comprises, but is not limited to, BT, WiFi, Zigbee, infrared and the like. Optionally, the sending module 64 and the UE perform communication by using a BT wireless communication technology, correspondingly, the sending module 64 comprises a BT communication unit, and further optionally, the receiving module 62 and the sending module 64 share a BT communication unit.

For example, if a first UE is respectively associated with an article A and an article B in the at least one association relationship established by the association module 63, the sending module 64 sends an alert indicating that the article A and the article B are placed on the article holding apparatus to the first UE; if a second UE is associated with an article C in the at least one association relationship established by the association module 63, the sending module 64 sends an alert indicating that the article C is placed on the article holding apparatus to the second UE.

In this embodiment, after receiving the alert sent by the sending module 64, the UE may alert the user.

The alert apparatus in this embodiment, by, in response to that a first detection module detects that at least one object is newly placed on the article holding apparatus and signal strength of a wireless signal received by a receiving module exceeds a first value, establishing, by an association module, at least one association relationship respectively between the at least one object and a UE sending the wireless signal, and sending, by a sending module, an alert indicating that the at least one object is placed on the article holding apparatus to the UE based on the at least one association relationship, provides an alert solution, which is applicable no matter whether the object has wireless communication capability.

The alert apparatus 600 of this embodiment is further described below through some example embodiments.

In this embodiment, the first detection module 61 and the receiving module 62 cooperate with each other in manner manners.

In one example embodiment, the receiving module 62 is specifically configured to: in response to that the first detection module 61 detects that the at least one object is newly placed on the article holding apparatus, determine whether a wireless signal whose signal strength exceeds a first value is received within a first period of time.

The first period of time is relevant to the time when at least one object is newly placed on the article holding apparatus. Optionally, the first period of time is a period of time that takes the time when at least one object is newly placed on the article holding apparatus as an intermediate point. Specifically, duration of the first period of time may be preset.

For example, the first detection module 61 detects that at least one object is newly placed on the article holding apparatus at time t1, and the receiving module 62 determines whether a wireless signal whose signal strength exceeds a first value is received within a first period of time near the time t1.

In another example embodiment, the first detection module 61 is specifically configured to: in response to that the receiving module 62 determines that a wireless signal whose signal strength exceeds a first value is received, detect whether at least one object is newly placed on the article holding apparatus within a second period of time.

The second period of time is relevant to the time when the receiving module 62 receives a wireless signal whose signal strength exceeds a first value. Optionally, the second period of time is a period of time that takes the time when the receiving module 62 receives a wireless signal whose signal strength exceeds a first value as an intermediate point. Specifically, duration of the second period of time may be preset.

For example, the receiving module 62 receives a wireless signal at time t2 and determines that signal strength of the wireless signal exceeds the first value, and the first detection module 61 detects whether at least one object is newly placed on the article holding apparatus within a second period of time near the time t2.

In this embodiment, the sending module 64 may immediately send the alert to the UE after the association module 63 establishes the at least one association relationship, or may send the alert only if it is determined that a certain condition is met after the association module 63 establishes the at least one association relationship.

In one example embodiment, the receiving module 62 is further configured to: receive a query request from the UE; and
the sending module 64 is specifically configured to: alert the UE that the at least one object is placed on the article holding apparatus based on the at least one association relationship in response to that the receiving module 62 receives the query request from the

UE.

In another example embodiment, the sending module 64 is specifically configured to: alert the UE that the at least one object is placed on the article holding apparatus based on the at least one association relationship in response to that the UE is located in a preset region.

The preset region may be a region set previously, such as a doorway.

Whether the UE is located in a preset region may be determined in many manners, which comprise, but are not limited to: the alert apparatus 600 detects the position of the UE and judges whether the UE is located in a preset region, or the UE detects its own position, judges whether the UE is located in a preset region and notifies the alert apparatus 600 of the result, or the UE detects its own position and notifies the alert apparatus 600 of the position, and the alert apparatus 600 determines whether the UE is located in a preset region, or a third-party device other than the alert apparatus 600 and the UE detects the position of the UE, judges whether the UE is located in a preset region and notifies the alert apparatus 600 of the result, or the like.

Optionally, as shown in FIG. 6B, the alert apparatus 600 further comprises: a second detection module 65, configured to detect whether the UE is located in the preset region.

In another example embodiment, the sending module 64 is specifically configured to: alert the UE that the at least one object is placed on the article holding apparatus based on the at least one association relationship in response to that a distance between the UE and the article holding apparatus exceeds a second value.

The second value may be a value set previously, such as 10 m.

Whether a distance between the UE and the article holding apparatus exceeds a second value may be determined in many manners, which comprise, but are not limited to: the alert apparatus 600 detects positions of the article holding apparatus and the UE and judges whether a distance therebetween exceeds a second value, or the UE detects its own position and the position of the article holding apparatus, judges whether a distance therebetween exceeds a second value and notifies the alert apparatus 600 of the result, or the UE detects its own position and notifies the alert apparatus 600 of the position, and the alert apparatus 600 detects the position of the article holding apparatus and judges whether a distance between the UE and the article holding apparatus exceeds a second value, or a third-party device other than the alert apparatus 600 and the UE detects the position of the article holding apparatus and the position of the UE, judges whether a distance therebetween exceeds a second value and notifies the alert apparatus 600 of the result, or the like.

Optionally, as shown in FIG. 6C, the alert apparatus 600 further comprises: a third detection module 66, configured to detect whether a distance between the UE and the article holding apparatus exceeds a second value.

As the alert apparatus 600 and the article holding apparatus are usually set together, the distance between the UE and the alert apparatus 600 is equivalent to the distance between the UE and the article holding apparatus. Correspondingly, the third detection module 66 is specifically configured to detect whether a distance between the UE and the alert apparatus 600 exceeds a second value, and correspondingly, the sending module 64 is specifically configured to: in response to that the third detection module 63 detects that a distance between the UE and the alert apparatus 600 exceeds a second value, alert the UE that the at least one object is placed on the article holding apparatus based on the at least one association relationship. Optionally, the third detection module 66 comprises: a distance sensor.

It is noted that, in the example embodiment that the sending module 64 immediately sends the alert to the UE after the association module 63 establishes the at least one association relationship, the UE may also alert the user according to the alert sent by the sending module 64 when any of the above conditions is met, for example, the UE alerts the user in response to determining that the UE is located in a preset region.

In this embodiment, the first detection module 61 may comprise at least one sensor. In order to detect whether at least one object is newly placed on an article holding apparatus associated with the alert apparatus 600, optionally, the first detection module 61 comprises any one of the following: a visual sensor or a weighing sensor. For example, the visual sensor can continuously acquire visual images around the article holding apparatus, so as to determine whether at least one object is newly placed on the article holding apparatus; and the weighting sensor can continuously detect load-bearing on the article holding apparatus, and determine that at least one object is newly placed on the article holding apparatus when the load-bearing increases.

In this embodiment, in order to identify the at least one object newly placed on the article holding apparatus, optionally, the first detection module 61 is further configured to: in response to detecting that at least one object is newly placed on the article holding apparatus, detect placement information of the at least one object.

The placement information optionally comprises at least one of the following: an image, a shape, weight, a material and a placement region. Specifically, various kinds of placement information may be detected through corresponding sensors comprised in the first detection module 61. For example, the image of each object may be detected through a visual sensor; the shape of each object may be detected through an ultrasonic distance measurement sensor, an infrared sensor or the like; the weight of each object may be detected through various weighing sensors, for example, a resistance strain weighing sensor, an electromagnetic weighing sensor, a capacitance weighing sensor and the like; the material of the at least one object may be detected through an inductive proximity sensor, a capacitive proximity sensor, a Hall proximity sensor, a photoelectric sensor or the like; the placement region of each object may be detected through various position sensors, such as an electromagnetic position sensor, a photoelectric position sensor, a differential transformer position sensor, an eddy-current type position sensor, a capacitive position sensor, a reed switch position sensor, a Hall position sensor and the like.

In order to achieve a clearer alert, optionally, the sending module 64 is specifically configured to: send the placement information of the at least one object to the UE based on the at least one association relationship.

That is to say, the placement information of the at least one object is taken as the alert.

For example, after the receiving module 62 receives a query request from the UE, the sending module 64 sends the placement information of the at least one object to the UE based on the at least one association relationship.

In this embodiment, the object placed on the article holding apparatus may be removed, and further may be removed before the sending module 64 sends the alert to the UE.

In one example embodiment, the at least one object is a plurality of objects;
the first detection module 61 is further configured to: detect whether at least one object in the plurality of objects is removed from the article holding apparatus;
the association module 63 is further configured to: in response to that the first detection module 61 detects that the at least one object in the plurality of objects is removed from the article holding apparatus, delete at least one association relationship respectively between the removed at least one object and the UE; and
the sending module 64 is specifically configured to: in response to that there is still at least one object in the plurality of objects except the removed at least one object placed on the article holding apparatus, send an alert indicating that at least one object in the plurality of objects except the removed at least one object is placed on the article holding apparatus to the UE based on at least one remaining association relationship.

For example, the user uses the left hand wearing a smartband to place two books (represented with a book A and a book B for ease of description) on a table, at this time, the first detection module 61 detects that two objects are newly placed on the table, that is, the book A and the book B, and the receiving module 62 receives a wireless signal whose signal strength exceeds the first value sent by the smartband, and correspondingly, the association module 63 establishes two association relationship respectively between the book A and the book B and the smartband; afterwards, the first detection module 61 detects that the book A is removed from the table, the association module 63 deletes the association relationship between the book A and the smartband, and correspondingly, the association relationship between the book B and the smartband remains; then, the receiving module 62 receives a query request from the smartband, and the sending module 64 sends an alert indicating that the book B is placed on the table to the smartband based on the current association relationship.

It is noted that, if, before the sending module 64 sends the alert to the UE, all the objects associated with the UE are removed from the article holding apparatus, it is unnecessary to send the alert to the UE.

In this embodiment, optionally, the wireless signal carries a device ID of the UE; and the association module 63 is specifically configured to: in response to that the first detection module 61 detects that at least one object is newly placed on the article holding apparatus and signal strength of a wireless signal received by the receiving module 62 exceeds a first value, establish at least one association relationship respectively between the at least one object and the device ID.

For example, in the implementation of acquiring the placement information, optionally, the association module 63 is specifically configured to: in response to that the first detection module 61 detects that at least one object is newly placed on the article holding apparatus and signal strength of a wireless signal received by the receiving module 62 exceeds a first value, acquire placement information of the at least one object, and establish at least one association relationship respectively between the placement information of the at least one object and the device ID.

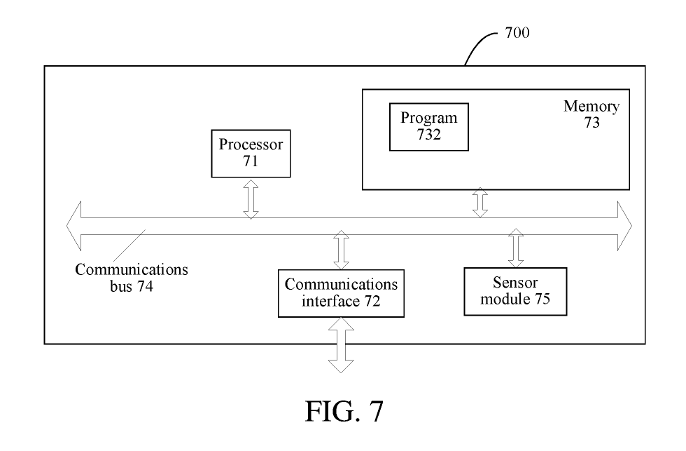

FIG. 7 is a schematic structural diagram of a third embodiment of an alert apparatus according to the present application. As shown in FIG. 7, the alert apparatus 700 comprises:
a processor 71, a communications interface 72, a memory 73, and a communications bus 74.

The processor 71, the communications interface 72, and the memory 73 accomplish mutual communications via the communications bus 74.

The communications interface 72 is configured to communicate with an external device such as a UE.

The processor 71 is configured to execute a program 732, and specifically, can implement relevant steps in the embodiments of the alert method.

Specifically, the program 732 may comprise a program code, the program code comprising a computer operation instruction.

The processor 71 may be a central processing unit (CPU), or an application specific integrated circuit (ASIC), or be configured to be one or more integrated circuits which implement the embodiments of the alert method.

The memory 73 is configured to store the program 732. The memory 73 may comprise a high-speed RAM memory, and may also comprise a non-volatile memory, for example, at least one magnetic disk memory. The program 732 may be specifically configured to cause the alert apparatus 700 to implement the following steps:
in response to determining that at least one object is newly placed on an article holding apparatus associated with the alert apparatus 700 and a wireless signal whose signal strength exceeds a first value is received, establishing at least one association relationship respectively between the at least one object and a UE sending the wireless signal; and
alerting the UE that the at least one object is placed on the article holding apparatus based on the at least one association relationship.

Reference can be made to the corresponding description in the corresponding embodiments of the alert method for specific implementation of the steps in the program 732, which is not repeated herein.

Optionally, the alert apparatus 700 further comprises: a sensor module 75 which comprises various kinds of sensors.

Those skilled in the art can clearly understand that, reference can be made to the corresponding process description in the embodiments of the alert method for the apparatus described above and the specific working procedures of the modules, and will not be repeated herein in order to make the description convenient and concise.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such implementation should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a server, or a network device, and the like) to execute all or some steps of the method described in each embodiment of the present application. The foregoing storage medium comprises, a USB disk, a removable hard disk, a read-only memory (ROM), a random access memory (RAM), a magnetic disk, an optical disk or any other mediums that can store program codes.

The above implementations are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
in response to determining that at least one object has been newly placed on an article holding apparatus associated with an alert apparatus comprising a processor and in response to determining that a wireless signal whose signal strength exceeds a first value has been received, establishing, by the alert apparatus, at least one association relationship respectively between the at least one object and a user equipment (UE) sending the wireless signal; and
alerting the UE that the at least one object has been placed on the article holding apparatus based on the at least one association relationship.

2. The method of claim 1, wherein, before the establishing the at least one association relationship, the method further comprises:
determining, by the alert apparatus, whether the at least one object has been newly placed on the article holding apparatus; and
in response to the determining that the at least one object has been newly placed on the article holding apparatus, determining whether the wireless signal whose signal strength exceeds the first value has been received within the first period of time; or
determining, by the alert apparatus, whether the wireless signal whose signal strength exceeds the first value has been received; and
in response to the determining that the wireless signal whose signal strength exceeds the first value has been received, determining, by the alert apparatus, whether the at least one object has been newly placed on the article holding apparatus within a second period of time.

3. The method of claim 1, wherein the alerting the UE that the at least one object has been placed on the article holding apparatus based on the at least one association relationship comprises:
alerting the UE that the at least one object has been placed on the article holding apparatus based on the at least one association relationship in response to determining that a query request from the UE is received; or
alerting the UE that the at least one object has been placed on the article holding apparatus based on the at least one association relationship in response to determining that the UE is located in a preset region; or
alerting the UE that the at least one object has been placed on the article holding apparatus based on the at least one association relationship in response to determining that a distance between the UE and the article holding apparatus exceeds a second value.

4. The method of claim 1, wherein the establishing the at least one association relationship comprises:
in response to the determining that the at least one object has been newly placed on the article holding apparatus and the determining that the wireless signal whose signal strength exceeds the first value has been received, acquiring, by the alert apparatus, placement information of the at least one object, and establishing the at least one association relationship respectively between the placement information of the at least one object and a UE sending the wireless signal.

5. The method of claim 4, wherein the placement information comprises at least one an image, a shape, weight, a material or a placement region.

6. The method of claim 4, wherein the alerting the UE that the at least one object has been placed on the article holding apparatus based on the at least one association relationship comprises:
sending the placement information of the at least one object to the UE based on the at least one association relationship.

7. The method of claim 1, wherein the at least one object is a plurality of objects,
wherein, after the establishing the at least one association relationship, the method further comprises: in response to determining that an object in the plurality of objects has been removed from the article holding apparatus, deleting the at least one association relationship respectively between the object that was removed and the UE, and
wherein the alerting the UE that the at least one object has been placed on the article holding apparatus based on the at least one association relationship comprises: in response to determining that there is still another object in the plurality of objects placed on the article holding apparatus after the object in the plurality of objects is removed from the article holding apparatus, alerting the UE that the other object in the plurality of objects except the object that was removed has been placed on the article holding apparatus based on at least one remaining association relationship of the at least one association relationship.

8. The method of claim 1, wherein the wireless signal is sent by the UE periodically.

9. The method of claim 1, wherein the wireless signal carries a device ID of the UE, and
wherein the establishing the at least one association relationship respectively between the at least one object and the UE sending the wireless signal comprises: establishing the at least one association relationship respectively between the at least one object and the device ID.

10. The method of claim 1, wherein the article holding apparatus is a table, and the alert apparatus is attached to or embedded into a table top of the table.

11. The method of claim 1, wherein the UE is a portable device.

12. An apparatus, comprising:
a memory that stores executable modules; and
a processor, couple to the memory, that executes or facilitates execution of the executable modules, the executable modules comprising:
an association establishment module configured to, in response to determining that at least one object is newly placed on an article holding apparatus associated with the apparatus and a wireless signal whose signal strength exceeds a first value is received, establish at least one association relationship respectively between the at least one object and a user equipment (UE) sending the wireless signal; and
an alert module configured to alert the UE that the at least one object is placed on the article holding apparatus based on the at least one association relationship.

13. The apparatus of claim 12, wherein the executable modules further comprise:
a first determination module configured to determine whether the at least one object is newly placed on the article holding apparatus; and
a second determination module configured to, in response to determining that the at least one object is newly placed on the article holding apparatus, determine whether the wireless signal whose signal strength exceeds the first value is received within a first period of time; or
a third determination module configured to determine whether the wireless signal whose signal strength exceeds the first value is received; and
a fourth determination module, configured to in response to determining that the wireless signal whose signal strength exceeds the first value is received, determine whether the at least one object is newly placed on the article holding apparatus within a second period of time.

14. The apparatus of claim 12, wherein the alert module is further configured to:
alert the UE that the at least one object is placed on the article holding apparatus based on the at least one association relationship in response to determining that a query request from the UE is received; or
alert the UE that the at least one object is placed on the article holding apparatus based on the at least one association relationship in response to determining that the UE is located in a preset region; or
alert the UE that the at least one object is placed on the article holding apparatus based on the at least one association relationship in response to determining that a distance between the UE and the article holding apparatus exceeds a second value.

15. The apparatus of claim 12, wherein the association establishment module is further configured to: in response to the determining that the at least one object is newly placed on the article holding apparatus and the wireless signal whose signal strength exceeds the first value is received, acquire placement information of the at least one object, and establish the at least one association relationship respectively between the placement information of the at least one object and the UE sending the wireless signal.

16. The apparatus of claim 15, wherein the placement information comprises at least one of an image, a shape, weight, a material or a placement region.

17. The apparatus of claim 15, wherein the alert module is further configured to:
send the placement information of the at least one object to the UE based on the at least one association relationship.

18. The apparatus of claim 12, wherein the at least one object is a plurality of objects,
wherein the executable modules further comprise: an association deletion module configured to, in response to determining that at least one first object in the plurality of objects is removed from the article holding apparatus, delete at least one association relationship respectively between the at least one object first and the UE, and
wherein the alert module is further configured to: in response to determining that there is still at least one second object in the plurality of objects placed on the article holding apparatus after the at least one first object in the plurality of objects is removed from the article holding apparatus, alert the UE that at least one second object in the plurality of objects except the at least one first object is placed on the article holding apparatus based on at least one remaining association relationship of the at least one association relationship.

19. The apparatus of claim 12, wherein the wireless signal is sent by the UE periodically.

20. The apparatus of claim 12, wherein the wireless signal carries a device ID of the UE; and
the association establishment module is further configured to: in response to the determining that the at least one object is newly placed on the article holding apparatus associated with the apparatus and the wireless signal whose signal strength exceeds the first value is received, establish the at least one association relationship respectively between the at least one object and the device ID.

21. An apparatus, comprising:
a memory that stores executable modules; and
a processor, couple to the memory, that executes or facilitates execution of the executable modules, the executable modules comprising:
a first detection module configured to detect whether at least one object is newly placed on an article holding apparatus associated with the apparatus;
a receiving module configured to receive a wireless signal, and determine whether a signal strength of the wireless signal exceeds a first value;
an association module configured to, in response to determining that the first detection module detects that the at least one object is newly placed on the article holding apparatus and the signal strength of the wireless signal received by the receiving module exceeds the first value, establish at least one association relationship respectively between the at least one object and a user equipment (UE) sending the wireless signal; and
a sending module configured to send to the UE an alert indicating that the at least one object is placed on the article holding apparatus based on the at least one association relationship.

22. The apparatus of claim 21, wherein the receiving module is further configured to: in response to determining that the first detection module detects that the at least one object is newly placed on the article holding apparatus, determine whether the wireless signal whose signal strength exceeds the first value is received within a first period of time.

23. The apparatus of claim 21, wherein the first detection module is further configured to: in response to determining that the receiving module receives the wireless signal whose signal strength exceeds the first value, detect whether the at least one object is newly placed on the article holding apparatus within a second period of time.

24. The apparatus of claim 21, wherein the receiving module is further configured to: receive a query request from the UE, and
wherein the sending module is further configured to: alert the UE that the at least one object is placed on the article holding apparatus based on the at least one association relationship in response to determining that the receiving module receives the query request from the UE.

25. The apparatus of claim 21, wherein the sending module is further configured to:
alert the UE that the at least one object is placed on the article holding apparatus based on the at least one association relationship in response to determining that the UE is located in a preset region.

26. The apparatus of claim 25, wherein the executable modules further comprise: a second detection module configured to detect whether the UE is located in the preset region.

27. The apparatus of claim 21, wherein the sending module is further configured to: alert the UE that the at least one object is placed on the article holding apparatus based on the at least one association relationship in response to determining that a distance between the UE and the article holding apparatus exceeds a second value.

28. The apparatus of claim 27, wherein the executable modules further comprise: a third detection module configured to detect whether the distance between the UE and the article holding apparatus exceeds the second value.

29. The apparatus of claim 21, wherein the first detection module comprises at least one of a visual sensor or a weighing sensor.

30. The apparatus of claim 21, wherein the first detection module is further configured to: in response to detecting that the at least one object is newly placed on the article holding apparatus, detect placement information of the at least one object.

31. The apparatus of claim 30, wherein the placement information comprises at least one of an image, a shape, weight, a material or a placement region.

32. The apparatus of claim 30, wherein the sending module is further configured to: send the placement information of the at least one object to the UE based on the at least one association relationship.

33. The apparatus of claim 21, wherein the at least one object is a plurality of objects,
wherein the first detection module is further configured to: detect whether an object in the plurality of objects is removed from the article holding apparatus,
wherein the association module is further configured to: in response to determining that the first detection module detects that the object in the plurality of objects is removed from the article holding apparatus, delete at least one association relationship respectively between the object and the UE, and
wherein the sending module is further configured to: in response to determining that there is still another object in the plurality of objects placed on the article holding apparatus after the object in the plurality of objects is removed from the article holding apparatus, send to the UE an alert indicating that the other object in the plurality of objects except the object is placed on the article holding apparatus based on at least one remaining association relationship of the at least one association relationship.

34. The apparatus of claim 21, wherein the article holding apparatus is a table, and the apparatus is attached to or embedded into a table top of the table.

35. A computer readable storage device comprising executable instructions that, in response to execution, cause a device comprising a processor to perform operations, comprising:
in response to determining that an object has been newly placed on an article holding apparatus associated with the device and a wireless signal having a signal strength determined to exceed a first value has been received, establishing an association relationship respectively between the object and a user equipment (UE) determined to have sent the wireless signal; and
sending an alert directed to the UE indicating to the UE that the object has been placed on the article holding apparatus based on the association relationship.
